(19) United States
(12) Patent Application Publication
(10) Pub. No.: US 2026/0245083 A1
(43) Pub. Date: Aug. 20, 2026

(54) CONTROL METHOD, DEVICE, AND RECORDING MEDIUM

(71) Applicant: Panasonic Intellectual Property Management Co., Ltd., Osaka (JP)

(72) Inventors: Takeru KOIE, Saitama (JP); Kakuya Yamamoto, Hyogo (JP); Yuji Unagami, Osaka (JP)

(21) Appl. No.: 19/646,137

(22) Filed: Apr. 13, 2026

Related U.S. Application Data
(63) Continuation of application No. PCT/JP2024/037475, filed on Oct. 22, 2024.
(60) Provisional application No. 63/545,628, filed on Oct. 25, 2023.

(51) Int. Cl. G06Q 20/38; G06F 16/2455

(52) U.S. Cl. CPC G06Q 20/389; G06F 16/2455

(57) ABSTRACT

A control method performed by a device includes obtaining a non-fungible token (NFT) issuance request for creating an NFT from first content, and sending, to a blockchain system, transaction data including request information for requesting the blockchain system to issue the NFT corresponding to the first content. The NFT includes a correspondence relationship between first information and second information, the first information indicating a range of the first content where at least part of second content different from the first content is present, and the second information indicating a range of the second content where the at least part of the second content is present. The request information includes the correspondence relationship.

### CROSS REFERENCE TO RELATED APPLICATIONS

This is a continuation application of PCT International Application No. PCT/JP2024/037475 filed on October 22, 2024, designating the United States of America, which is based on and claims priority of U.S. Provisional Patent Application No. 63/545628 filed on October 25, 2023. The entire disclosures of the above-identified applications, including the specifications, drawings and claims are incorporated herein by reference in their entirety.

### FIELD

The present disclosure relates to a control method, a device, and a recording medium.

### BACKGROUND

Patent Literature (PTL) 1 discloses a technique for buying and selling non-fungible tokens (NFTs) for proving the authenticity of digital content or the owner of digital content.

### Citation List

### Patent Literature

PTL 1: Japanese Patent No. 7129579

### SUMMARY

### Technical Problem

The present disclosure provides a control method and the like enabling the recording of a correspondence relationship between first content and second content sharing at least a part of the first content.

### Solution to Problem

A control method according to one aspect of the present disclosure is a control method performed by a device. The control method includes: obtaining a non-fungible token (NFT) issuance request for creating an NFT from first content, and sending, to a blockchain system, transaction data including request information for requesting the blockchain system to issue the NFT corresponding to the first content. The NFT includes a correspondence relationship between first information and second information, the first information indicating a range of the first content where at least part of second content different from the first content is present, and the second information indicating a range of the second content where the at least part of the second content is present. The request information includes the correspondence relationship.

A device according to one aspect of the present disclosure is a device including a processor and a memory. Using the memory, the processor: obtains a non-fungible token (NFT) issuance request for creating an NFT from first content; and sends, to a blockchain system, transaction data including request information for requesting the blockchain system to issue the NFT corresponding to the first content. The NFT includes a correspondence relationship between first information and second information, the first information indicating a range of the first content where at least part of second content different from the first content is present, and the second information indicating a range of the second content where the at least part of the second content is present. The request information includes the correspondence relationship.

Note that these comprehensive or specific aspects may be realized by a system, a device, an integrated circuit, a computer program, or a computer-readable recording medium such as a CD-ROM, or may be implemented by any desired combination of systems, devices, integrated circuits, computer programs, and recording media.

### Advantageous Effects

According to a control method and the like of the present disclosure, a correspondence relationship between first content and second content sharing at least a part of the first content can be recorded.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the configuration of a system according to an embodiment.

FIG. 2 is a block diagram illustrating an example of the configuration of a service server according to the embodiment.

FIG. 3 is a block diagram illustrating an example of the configuration of a management server according to the embodiment.

FIG. 4 is a diagram illustrating a case where content is generated over three generations.

FIG. 5 is a diagram illustrating an example of the configuration of an NFT according to the embodiment.

FIG. 6 is a diagram illustrating a specific example of a temporal range in reference source and reference destination content.

FIG. 7 is a diagram illustrating a specific example of a spatial range in reference source and reference destination content.

FIG. 8 is a sequence chart illustrating a first example of operations performed by the system according to the embodiment.

FIG. 9 is a flowchart illustrating a specific example of similar content search processing according to the embodiment.

FIG. 10 is a sequence chart illustrating a second example of operations performed by the system according to the embodiment.

FIG. 11 is an explanatory diagram illustrating the data structure of a blockchain.

FIG. 12 is an explanatory diagram illustrating the data structure of transaction data.

FIG. 13 is an explanatory diagram illustrating transaction data related to the execution of a smart contract.

FIG. 14 is an explanatory diagram illustrating processing related to the execution of a smart contract.

### DESCRIPTION OF EMBODIMENT

### Underlying Knowledge Forming Basis of the Present Disclosure

Recently, various types of digital content are being managed in association with NFTs. Using an NFT makes it possible to ensure the authenticity of the digital content and easily identify the owner of the digital content.

There are cases where new digital content (second-generation content) is generated using at least a part of existing digital content (first-generation content). In this case, the relationship between the second-generation content and the first-generation content can be recorded in a blockchain by generating an NFT including information for identifying the first-generation content (e.g., an NFT ID of the first-generation content) as an NFT of the second-generation content.

However, with the foregoing technique, if subsequent third-generation content is generated using part of the second-generation content, situations arise where the first-generation content is not included in the third-generation content. In such a case, a part of the second-generation content included in the third-generation content may be different from a part of the first-generation content included in the second-generation content, for example. In this case, the third-generation content will be managed on the blockchain as content related to the first-generation content through the second-generation content, even if the third-generation content does not include part of the first-generation content.

The inventors of the present disclosure arrived at a control method and the like that enable the appropriate management of a correspondence relationship between new content and other content included in the new content.

A control method according to a first aspect of the present disclosure is a control method performed by a device. The control method includes: obtaining a non-fungible token (NFT) issuance request for creating an NFT from first content; and sending, to a blockchain system, transaction data including request information for requesting the blockchain system to issue the NFT corresponding to the first content. The NFT includes a correspondence relationship between first information and second information, the first information indicating a range of the first content where at least part of second content different from the first content is present, and the second information indicating a range of the second content where the at least part of the second content is present. The request information includes the correspondence relationship.

Through this, the first information indicating the range of the first content where at least a part of the second content is present, and the second information indicating the range of the second content where at least a part of the second content is present, are associated with each other by the correspondence relationship. Additionally, an NFT including the correspondence relationship can be stored in the blockchain. Accordingly, a correspondence relationship between parts that are common in the first content and the second content can easily be identified on the blockchain.

Through this, even if further additional content includes a part of the second content, recording a correspondence relationship between the additional content and the second content in the same manner as the correspondence relationship between the first content and the second content makes it possible to identify whether the part of the first content included in the second content is included in the additional content. In this manner, even if subsequent content is generated so as to share a part of the previous content, and the subsequent content is generated across a plurality of generations, the content whose part is included in the new content can be identified with ease.

In this manner, when an interest in new content arises, other content included in the new content can be identified, which makes it possible to easily distribute profit from the interest that has arisen to the creator or the owner of the other content included in the new content. In other words, all the people involved in the generation of the new content can be identified, which makes it possible to select candidates to which the profit produced by the new content is to be distributed from among those people. In this manner, candidates to which the profit produced by the new content is to be distributed can be selected from among all the people involved in the generation of the new content, and it is therefore possible that the profit will be distributed fairly.

A control method according to a second aspect of the present disclosure is the control method according to the first aspect, wherein the second content is content referenced when a creator generates the first content.

Accordingly, a correspondence relationship between parts that are common between the first content and the second content referenced when generating the first content can easily be identified on the blockchain.

A control method according to a third aspect of the present disclosure is the control method according to the first aspect or the second aspect, wherein the first information indicates a temporal range of the first content where the at least part of the second content is present, and the second information indicates a temporal range of the second content where the at least part of the second content is present.

Accordingly, a correspondence relationship between temporal ranges, in which parts that are common between the first content and the second content referenced when generating the first content are present in each of the first content and the second content, can be identified with ease on the blockchain.

A control method according to a fourth aspect of the present disclosure is the control method according to any one of the first aspect to the third aspect, wherein the first information indicates a spatial range of the first content where the at least part of the second content is present, and the second information indicates a spatial range of the second content where the at least part of the second content is present.

Accordingly, a correspondence relationship between spatial ranges, in which parts that are common between the first content and the second content referenced when generating the first content are present in each of the first content and the second content, can be identified with ease on the blockchain.

A control method according to a fifth aspect of the present disclosure is the control method according to any one of the first aspect to the fourth aspect, wherein the first content and the second content associated with each other by the correspondence relationship are of a same type.

A control method according to a sixth aspect of the present disclosure is the control method according to the fifth aspect, wherein each of the first content and the second content includes a plurality of types of sub-content, and the correspondence relationship includes a first correspondence relationship for a first type of the sub-content and a second correspondence relationship for a second type of the sub-content.

Accordingly, a correspondence relationship can be recorded on the blockchain for each type of sub-content included in each of the first content and the second content.

A control method according to a seventh aspect of the present disclosure is the control method according to the sixth aspect, wherein the plurality of types of sub-content include image content and audio content, the first type of the sub-content is the image content, the second type of the sub-content is the audio content, the first correspondence relationship includes a correspondence relationship between temporal ranges where the at least part of the second content is present and a correspondence relationship between spatial ranges where the at least part of the second content is present, and the second correspondence relationship includes a correspondence relationship between the temporal ranges where the at least part of the second content is present.

A control method according to an eighth aspect of the present disclosure is the control method according to any one of the first aspect to the seventh aspect, further including searching a plurality of items of content stored in a storage device for one or more items of similar content similar to the first content, and generating the correspondence relationship for each of one or more combinations of each of the one or more items of similar content and the first content. The request information is information requesting the blockchain system to issue an NFT including one or more correspondence relationships, each being the correspondence relationship generated.

Accordingly, a correspondence relationship between the first content and each of the one or more items of similar content among the plurality of items of content already stored in the storage device can be recorded on the blockchain.

A control method according to a ninth aspect of the present disclosure is the control method according to the eighth aspect, wherein the searching includes extracting a feature of the first content based on the first content, and searching for the one or more items of similar content similar to the first content by comparing the feature with a feature of each of the plurality of items of content.

This makes it possible to appropriately search for the one or more items of similar content similar to the first content.

A control method according to a tenth aspect of the present disclosure is the control method according to the ninth aspect, wherein when a first item of similar content, among the one or more items of similar content, includes all the first content, the sending of the transaction data to the blockchain system is skipped.

Accordingly, the creation of an NFT for the same content as content for which an NFT has already been created can be rejected.

A control method according to an eleventh aspect of the present disclosure is the control method according to any one of the first aspect to the seventh aspect, wherein the obtaining further includes obtaining a list of one or more items of reference content referenced when a creator generates the first content. The control method further includes: obtaining, based on the list, the one or more items of reference content from a storage device storing a plurality of items of content; identifying one or more items of similar content similar to the first content based on a comparison between each of the one or more items of reference content and the first content; and generating the correspondence relationship for each of one or more combinations of each of the one or more items of similar content and the first content. The request information is information requesting the blockchain system to issue an NFT including one or more correspondence relationships, each being the correspondence relationship generated.

Accordingly, one or more items of similar content can be identified from one or more items of reference content included in the list.

A device according to a twelfth aspect of the present disclosure includes a processor and a memory. Using the memory, the processor: obtains a non-fungible token (NFT) issuance request for creating an NFT from first content, and sends, to a blockchain system, transaction data including request information for requesting the blockchain system to issue the NFT corresponding to the first content. The NFT includes a correspondence relationship between first information and second information, the first information indicating a range of the first content where at least part of second content different from the first content is present, and the second information indicating a range of the second content where the at least part of the second content is present. The request information includes the correspondence relationship.

Through this, the first information indicating the range of the first content where at least a part of the second content is present, and the second information indicating the range of the second content where at least a part of the second content is present, are associated with each other by the correspondence relationship. Additionally, an NFT including the correspondence relationship can be stored in the blockchain. Accordingly, a correspondence relationship between parts that are common in the first content and the second content can easily be identified on the blockchain.

Through this, even if further additional content includes a part of the second content, recording a correspondence relationship between the additional content and the second content in the same manner as the correspondence relationship between the first content and the second content makes it possible to identify whether the part of the first content included in the second content is included in the additional content. In this manner, even if subsequent content is generated so as to share a part of the previous content, and the subsequent content is generated across a plurality of generations, the content whose part is included in the new content can be identified with ease.

A recording medium having recorded thereon a program according to a thirteenth aspect of the present disclosure is a non-transitory computer-readable recording medium having recorded thereon a program for causing a computer to execute a control method performed by a device. The control method includes: obtaining a non-fungible token (NFT) issuance request for creating an NFT from first content, and sending, to a blockchain system, transaction data including request information for requesting the blockchain system to issue the NFT corresponding to the first content. The NFT includes a correspondence relationship between first information and second information, the first information indicating a range of the first content where at least part of second content different from the first content is present, and the second information indicating a range of the second content where the at least part of the second content is present. The request information includes the correspondence relationship.

Note that these comprehensive or specific aspects may be realized by a system, a device, an integrated circuit, a computer program, or a computer-readable recording medium such as a CD-ROM, or may be implemented by any desired combination of systems, devices, integrated circuits, computer programs, and recording media.

An embodiment will be described hereinafter with reference to the drawings. Note that the following embodiment describes specific examples of the present disclosure. In other words, the numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims indicating the broadest interpretation are not absolutely necessary for solving the problem of the present disclosure, and will instead be described as constituent elements constituting more preferred forms.

### Embodiment

The present embodiment will describe a control method and the like through which profit from the buying and selling of an NFT corresponding to content information can be appropriately distributed to a creator of the content information.

### System Configuration

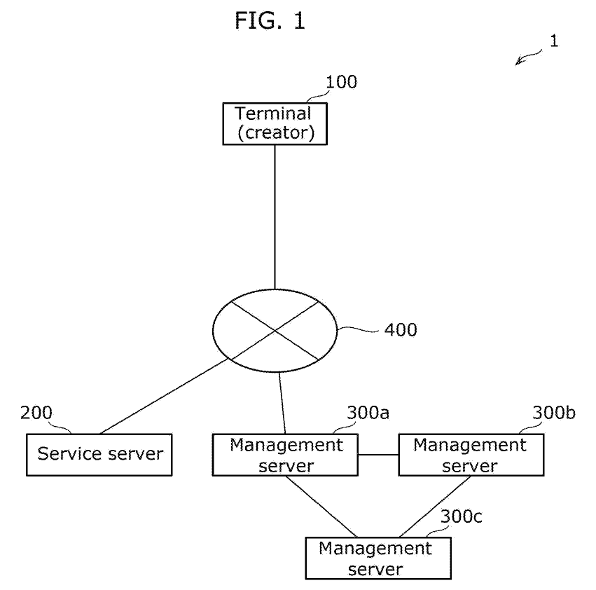

FIG. 1 is a block diagram illustrating the configuration of a system according to the embodiment.

As illustrated in FIG. 1, system 1 includes terminal 100, service server 200, and management servers 300a to 300c (also referred to as “management server 300a and the like”). Terminal 100, service server 200, and management servers 300a to 300c may all be connected to each other over network 400, may all be communicatively connected directly to each other, or some may be communicatively connected over network 400 while others are communicatively connected directly. Network 400 is, for example, the Internet, a cellular telephone carrier network, or the like, but may be constituted by any communication line or network.

Service server 200 is a computer that manages the creation of an NFT for digital content applied for by a user such as a creator. When digital content is obtained along with an NFT issuance request for the digital content from terminal 100 of the creator, service server 200 requests management servers 300a to 300c to issue an NFT for the obtained digital content in response to the NFT issuance request.

Management server 300a is a server that manages NFTs for digital content using a distributed ledger. Management server 300a stores the distributed ledger in storage. When transaction data indicating an issuance request for an NFT is received from service server 200, management server 300a executes processing for issuing an NFT for the digital content based on the received transaction data.

Management server 300a can send and receive communication data to and from the other management servers 300b and 300c. Management server 300a sends the received transaction data to the other management servers 300b and 300c to cause the transaction data to be stored in the distributed ledger held by the other management servers 300b and 300c as well. When storing the transaction data, the transaction data may be stored after first using a consensus algorithm to form a consensus. The transaction data stored in the distributed ledger is managed using properties such as hash values to prevent tampering (described later).

For example, when the distributed ledger is a blockchain, management server 300a generates a block containing the new transaction data and stores the block in the distributed ledger after using a consensus algorithm to form a consensus with management server 300a and the like for the generated block. Note that the format of the distributed ledger is not limited to the foregoing, and other distributed ledger formats (e.g., IOTA, Hashgraph, or the like) can also be used.

Management servers 300b and 300c are management servers similar to management server 300a, and operate independently from management server 300a.

Note that a management server group including management server 300a and the like can also be referred to as a “distributed ledger network” or a blockchain system”. Although a case where three of management server 300a and the like are included in the distributed ledger network is described as an example, the number of management server 300a and the like may be four or more.

Terminal 100 is an information processing terminal in the possession of a creator, who is a user. Terminal 100 includes a CPU, memory, storage, a display screen, and the like, and processes information by the CPU executing predetermined programs using the memory. Terminal 100 is, for example, a smartphone, a tablet terminal, a personal computer, or the like.

Note that a device group including service server 200 and management server 300a and the like is a device group involved in NFT generation or other processing, and can also be referred to as an “NFT network”. In other words, “NFT” is a non-fungible token, and is typically a token that conforms to the Ethereum blockchain standard of ERC721, but may be a token of another standard or a non-standard token, or a token other than Ethereum. Although ERC721 is a standard for unique tokens, the NFTs herein need not be unique, e.g., a single NFT may correspond to ten objects. In addition, a plurality of NFTs may be assigned to the same object, e.g., the same object may have different NFTs today and tomorrow, or different NFTs for the same object may be provided for organization A and organization B. The “token” may also be any data issued in association with data or a real object.

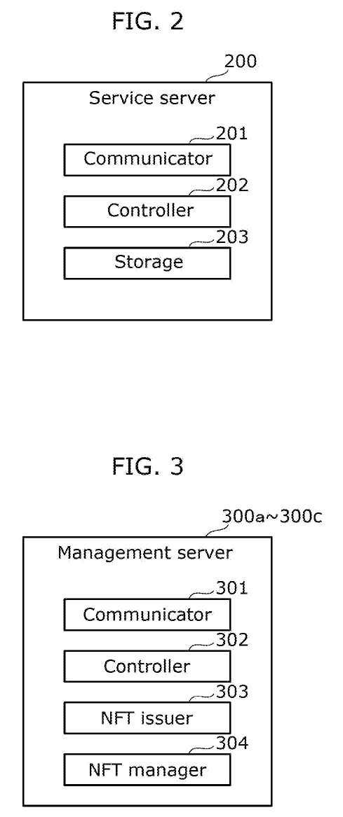

FIG. 2 is a block diagram illustrating an example of the configuration of the service server according to the embodiment.

As illustrated in FIG. 2, service server 200 includes communicator 201, controller 202, and storage 203. Communicator 201, controller 202, and storage 203 can be realized by a processor (e.g., a Central Processing Unit (CPU)) (not shown) included in service server 200 executing predetermined programs using a memory (not shown). Service server 200 is an example of a device.

Communicator 201 communicates over network 400 with at least one of terminal 100 and management servers 300a to 300c. Communicator 201 receives information from at least one of terminal 100 and management servers 300a to 300c. Communicator 201 sends information to at least one of terminal 100 and management servers 300a to 300c.

Controller 202 executes various types of processing based on the received information. Specifically, controller 202 stores received information in storage 203. Controller 202 also executes processing for generating an NFT for received digital content. The processing for generating an NFT is, for example, processing for causing communicator 201 to send transaction data including request information requesting management servers 300a to 300c (the blockchain system) to issue an NFT.

Storage 203 stores data received by communicator 201. Specifically, storage 203 may store digital content received from terminal 100 and an NFT issuance request. Storage 203 may also store a database that manages a plurality of items of digital content for which NFTs have already been created.

Note that the database that manages a plurality of items of digital content (a content DB) may be stored in a storage device different from service server 200, and service server 200 may be communicatively connected to the storage device to be capable of accessing the database.

FIG. 3 is a block diagram illustrating an example of the configuration of the management servers according to the embodiment.

As illustrated in FIG. 3, each of management servers 300a to 300c includes communicator 301, controller 302, NFT issuer 303, and NFT manager 304.

Communicator 301 communicates with service server 200. Communicator 301 receives the NFT issuance request from service server 200. Communicator 301 sends a response to the NFT issuance request to service server 200 that sent the NFT issuance request.

Controller 302 executes various types of processing based on the received information.

NFT issuer 303 issues the NFT in response to the NFT issuance request.

NFT manager 304 records the issued NFT in the distributed ledger. As a result, a block including the NFT is added to the blockchain.

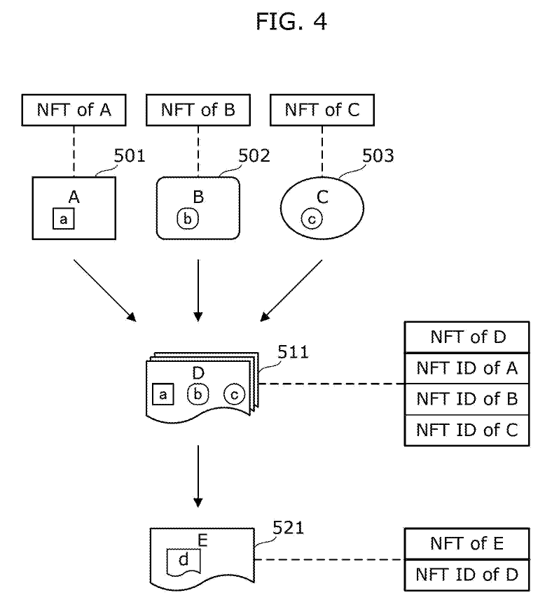

FIG. 4 is a diagram illustrating a case where content is generated over three generations.

For example, when second-generation content 511 is generated based on first-generation content 501, 502, and 503, content 511 includes part a of content 501, part b of content 502, and part c of content 503. An NFT corresponding to the content is issued for each item of content. An NFT of A is issued for content 501, an NFT of B is issued for content 502, an NFT of C is issued for content 503, and an NFT of D is issued for content 511.

Then, NFT IDs of the NFTs of A, B, and C corresponding to content 501, 502, and 503 originally including parts a, b, and c included in the corresponding content 511 are stored. By referring to the NFT of D, it can be seen that content 511 includes parts of content 501, 502, and 503.

Next, when third-generation content 521 is generated based on second-generation content 511, content 521 includes part d of content 511. An NFT of E corresponding to content 521 is issued for content 521.

Then, an NFT ID of the NFT of D corresponding to content 511 originally including part d included in the corresponding content 521 is stored. By referring to the NFT of E, it can be seen that content 521 includes part d of content 511.

By referring to the NFT of E, it can be seen that content 521 includes part d of content 511, and by referring to the NFT of D, it can be seen that content 511 includes parts a, b, and c of content 501, 502, and 503. As such, by referring to the NFT of E and the NFT of D, it can be seen that content 521 includes part d of content 511 and may include parts a, b, and c of content 501 to 503.

However, even referring to the NFT of E and the NFT of D, it is not known whether content 521 includes parts a, b, and c of content 501 to 503. This is because part d of content 511 included in content 521 does not necessarily include parts a, b, and c of content 501 to 503.

In this way, even if an NFT of a new generation of content is generated such that the NFT of the new generation of content includes an NFT ID of content from a previous generation of content, it is difficult to accurately manage the content included in the new generation of content.

Note that the “part” of the content may be part of a temporal range when the content has a time axis, such as moving image content and audio content. The “part” of the content may also be part of a spatial range (e.g., a partial region of a frame) when the content includes a spatial representation, such as moving image content and still image content. The moving image content or still image content is not limited to content using two-dimensional images (two-dimensional frames), and may be content using three-dimensional data (three-dimensional frames).

Note that in the present embodiment, “audio content” refers to content constituted by any sound, and is not limited to content that includes only human voice. The audio content is sound content.

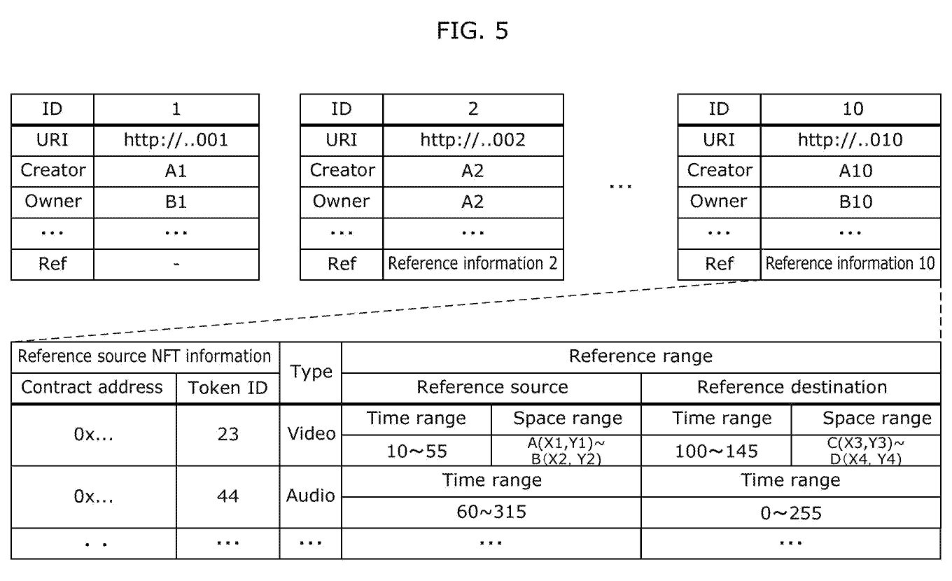

FIG. 5 is a diagram illustrating an example of the configuration of an NFT according to the embodiment.

The NFT includes an NFT ID, a URI indicating the address (storage location) where the content corresponding to the NFT (first content) is stored, identification information for identifying the creator who generated the first content, identification information for identifying the owner who owns the NFT, and reference information that is information about second content referenced when generating the first content. The first content is content including at least a part of the second content. The first content is content generated by referencing at least a part of the second content. The second content is content referenced when the creator generates the first content.

The reference information includes reference source NFT information that is NFT information of the second content serving as the reference source, type information indicating a type of the content, and a reference range indicating a reference source and a reference destination of a common part of the content.

The reference source NFT information includes a contract address of the NFT of the second content and a token ID as the NFT ID.

The type information indicates the type of the content. The type of the content includes images, audio, and the like. “Images” may further be classified into moving images and still images, and may be classified into two-dimensional content or three-dimensional content.

The reference range includes first information indicating a range where the common part of the content is present in the first content that is the reference destination, and second information indicating a range where the common part of the content is present in the second content that is the reference source. The reference range is an example of a correspondence relationship. The “common part” of the content is a part that is common between the first content and the second content, and is at least a part of the second content.

In the first information and the second information indicated in the correspondence relationship, the first information indicates a temporal range where the common part is present in the first content, and the second information indicates a temporal range where the common part is present in the second content. When the type of the first content and the second content is content having a time axis, the first information and the second information can indicate a temporal range. The content having a time axis is audio content, moving image content, or the like. The moving image content includes two-dimensional moving images and three-dimensional moving images.

Taking, for example, the time of the start of the first content as a reference, the “temporal range indicated by the first information” may be expressed by a start time and an end time of the common part, by the start time of the common part and a playback time of the common part, or by the end time of the common part and the playback time of the common part. Taking, for example, the time of the start of the second content as a reference, the “temporal range indicated by the second information” may be expressed by a start time and an end time of the common part, by the start time of the common part and a playback time of the common part, or by the end time of the common part and the playback time of the common part. Note that the temporal range need not be expressed as a time, and may be expressed as frames.

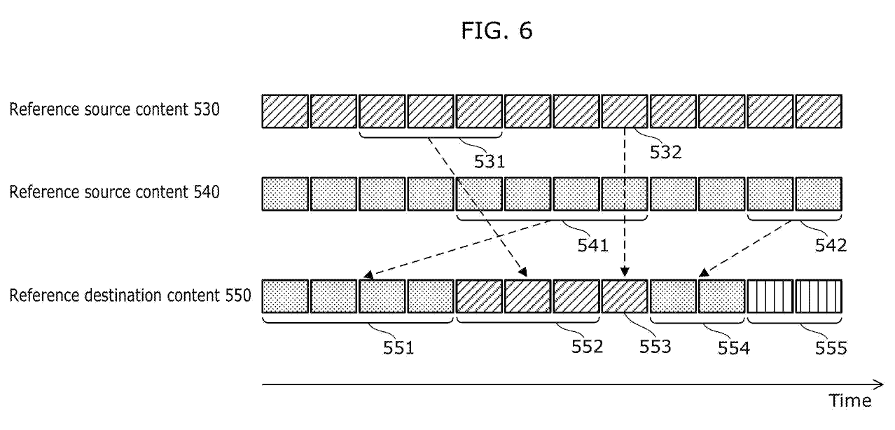

FIG. 6 is a diagram illustrating a specific example of the temporal range in reference source and reference destination content.

FIG. 6 illustrates a case where reference destination content 550 is generated with reference to two items of reference source content 530 and 540. In other words, reference destination content 550 includes parts of the two items of reference source content 530 and 540. The three items of content 530, 540, and 550 are content having a time axis.

Specifically, content 550 includes part 551 that is the same as part 541 of content 540, part 552 that is the same as part 531 of content 530, part 553 that is the same as part 532 of content 530, part 554 that is the same as part 542 of content 540, and part 555 of the original. Parts 551, 552, 553, 554, and 555 included in content 550 are all parts defined by the temporal range of content 550. In this manner, content 550 may include a temporal part of reference source content 530 and 540.

The descriptions will now return to FIG. 5.

In the first information and the second information indicated in the correspondence relationship, the first information indicates a spatial range where the common part is present in the first content, and the second information indicates a spatial range where the common part is present in the second content. When the first content and the second content are content including a spatial region, the first information and the second information can indicate a spatial range. The “content including a spatial region” is content such as a two-dimensional image, three-dimensional data, a two-dimensional moving image, a three-dimensional moving image, and the like.

The spatial range indicated by the first information is information designating a specific region of the spatial region of the first content, for example. The spatial range indicating the second information is information designating a specific region of the spatial region of the second content, for example.

When the content is two-dimensional content and the specific region is a rectangular region, the specific region may be represented by coordinates indicating the positions of the two opposing corners of the rectangular region. When the specific region has another shape, the specific region may be indicated by information representing the shape of the specific region and coordinates in the two-dimensional content of a point serving as a reference in the specific region. Note that information indicating the shape of the specific region may include information indicating the size of the shape. The specific region may also be represented by the coordinates of each of a plurality of pixels constituting an outline of the specific region.

Even if the content is three-dimensional content, the specific region may be represented by coordinates indicating the position of the specific region and information representing the shape of the specific region, as with two-dimensional content. The specific region may be represented in any other way other than the examples described above.

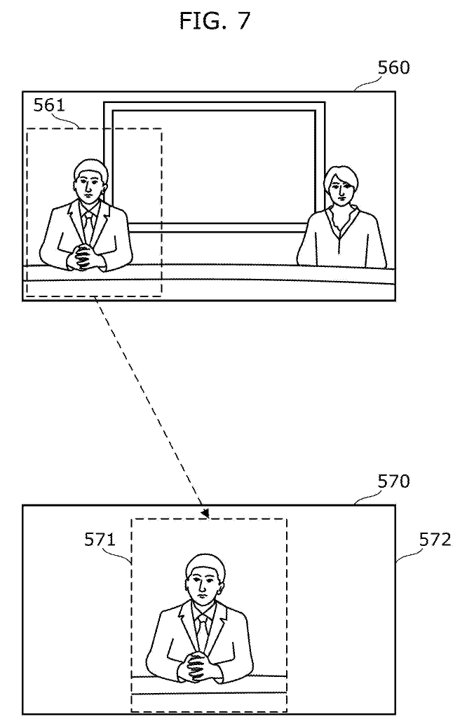

FIG. 7 is a diagram illustrating a specific example of the spatial range in reference source and reference destination content.

FIG. 7 illustrates a case where reference destination content 570 is generated with reference to one item of reference source content 560. In other words, reference destination content 570 includes part of the one item of reference source content 560. The two items of content 560 and 570 are content including a spatial region.

Specifically, content 570 includes part 571 that is the same as part 561 of content 560 and part 572 of the original. Parts 571 and 572 included in content 570 are both parts defined by the spatial range of content 570. In this manner, content 570 may include a spatial part of reference source content 560.

The descriptions will now return to FIG. 5.

As described above, the content includes a mixture of content having a time axis and content including a spatial region. The audio content is an example of content having a time axis, but is not content including a spatial region. The moving image content of the image content is content having a time axis and content that includes a spatial region. The still image content of the image content is content that does not have a time axis, but that includes a spatial region. In this manner, the content is classified according to the type of the content, whether the content has a characteristic of having a time axis, and whether the content has a characteristic of having a spatial region.

For this reason, the type of content determines whether the reference range is expressed as a temporal range or a spatial range. In content having a characteristic of having a time axis, the reference range can be indicated as a temporal range. Similarly, in content having a characteristic of having a spatial region, the reference range can be indicated as a spatial range.

Accordingly, the reference information defines a reference range for each type of content in a part of the content that is common between the reference source and reference destination content. Accordingly, if a plurality of common parts are present in a single item of reference destination content, a reference range is defined for each of the plurality of common parts in the reference information. Accordingly, reference information corresponding to a single item of reference destination content may have a plurality of correspondence relationships. For example, reference destination content 550 illustrated in FIG. 6 includes four parts 551, 552, 553, and 554 of content 550 as common parts, and thus the reference information corresponding to reference destination content 550 includes four correspondence relationships. Each of the four correspondence relationships is a correspondence relationship with counterpart content that shares the common part. As described above, the reference destination content (first content) and the reference source content (second content) associated with the correspondence relationship are of the same type.

When the reference destination and reference source content are moving image content including audio, the moving image content includes audio content and moving image content. In this case, the correspondence relationship includes a correspondence relationship in the audio and a correspondence relationship in the moving image (video). In this manner, each of the reference destination content and the reference source content may include a plurality of types of sub-content, and in this case, the correspondence relationship includes a first correspondence relationship for the first type of the sub-content and a second correspondence relationship for the second type of the sub-content. In other words, the plurality of types of sub-content include image content and audio content. The first type of the sub-content is the image content. The second type of the sub-content is the audio content. The first correspondence relationship includes a correspondence relationship between temporal ranges where the common part is present and a correspondence relationship between spatial ranges where the common part is present. The second correspondence relationship includes a correspondence relationship between temporal ranges where the common part is present.

### System Operations

Operations of the system configured as described above will be described next.

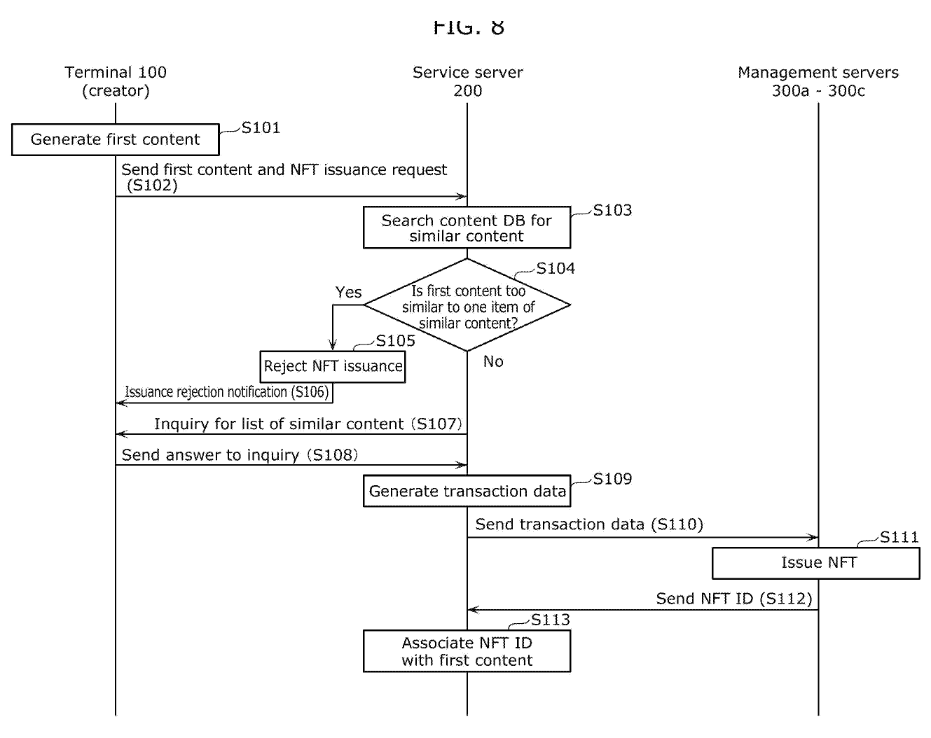

FIG. 8 is a sequence chart illustrating a first example of operations performed by the system according to the embodiment.

First, the creator operates terminal 100 to generate the first content. Accordingly, terminal 100 generates the first content (S101). The first content is the reference destination content.

Terminal 100 then sends the first content and an NFT issuance request for generating an NFT from the first content to service server 200 (S102). As a result, service server 200 obtains the first content generated by terminal 100 of the creator. Service server 200 need not obtain the first content directly from terminal 100 of the creator, and may obtain the first content through another terminal.

Upon obtaining the first content, service server 200 searches the content DB for similar content (S103). In other words, service server 200 searches a plurality of items of content stored in a storage device in which the database is managed for one or more items of similar content similar to the first content.

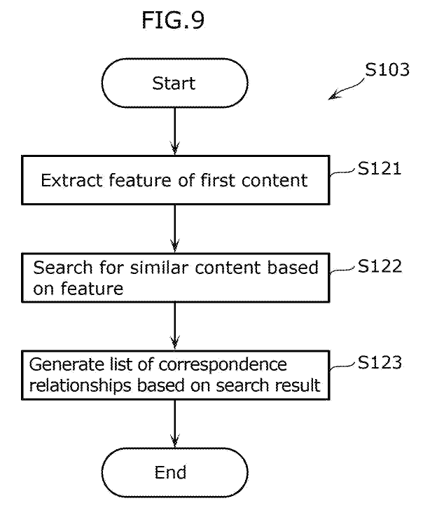

The processing of step S103 will be described in detail here with reference to FIG. 9.

FIG. 9 is a flowchart illustrating a specific example of similar content search processing according to the embodiment.

Service server 200 extracts a feature of the first content (S121). In the case of image content, the feature may be a feature based on the pixels of one frame (one two-dimensional image). The feature may be a color histogram representing a color distribution of the entire image or each of scenes, edge information indicating an outline or boundary in the image, texture features indicating a texture or pattern in the image, or a feature in an image of a local feature (SIFT, ORB, or the like). The features may also be a motion vector, an optical flow, or the like. In the case of audio content, the feature may be an acoustic feature. The feature may be a feature for a single frame or a feature for a certain single scene, or may be a feature evaluated for the content as a whole. These features may be expressed as multidimensional vectors.

Based on the feature of the first content extracted, service server 200 searches the plurality of items of content stored in the content DB for one or more items of similar content (S122). Service server 200 extracts features for each of the plurality of items of content in the same manner as for the first content and compares those features with each other, and identifies content having similar features as the similar content. Whether the features are similar to each other may be determined according to whether a difference between the features is less than a threshold set for each type of feature, when comparing single features with each other; or, when the features are expressed as multidimensional vectors, according to whether a distance between vectors is less than a predetermined threshold. Service server 200 can identify a common part between the first content in the similar content (the second content) by calculating and comparing the features for each spatial region unit or each temporal unit of the content, rather than only for the content as a whole.

Note that when searching for similar content, service server 200 may search for whether the same image is included in the content. The “same image” includes an image in which only subtitles or other objects have been added to the original image. Furthermore, when searching for similar content, service server 200 may also search for content that uses the same off-the-shelf source audio or sound effects as the target content (i.e., the first content). Furthermore, when searching for similar content, service server 200 may search for content including an image in which the arrangement of people or the cut is the same as in the target content. Furthermore, when searching for similar content, service server 200 may search for content including the same karaoke source audio or arrangement BGM as the target content. Additionally, service server 200 may search for content having the same story as the target content (e.g., a remake); content in which a featured character is the same as in the target content or in which a featured character from the target content appears in a partial scene (an episode in the same series, a sequel, a spinoff, or the like); or content including the same location or object as the target content (video including an interview at the same store, video of an interview with a person, or the like).

Service server 200 generates a list of correspondence relationships based on the search result (S123). As described above, service server 200 can identify a common part between the first content and the similar content (the second content), and thus the correspondence relationship for the common part can be generated. When two or more items of similar content are present, a plurality of common parts are identified, and a correspondence relationship is therefore generated for each of the plurality of common parts identified. In this manner, service server 200 generates the correspondence relationship for each of one or more combinations of each of the one or more items of similar content and the first content. Note that the list of correspondence relationships is also a list of the one or more items of similar content identified through the search.

This ends the processing of step S103.

The descriptions will now return to FIG. 8.

Next, service server 200 determines whether the first content is too similar to one item of similar content (S104). For example, if a first item of similar content among the one or more items of similar content includes all or at least a predetermined value of the first content, service server 200 determines that the first content is too similar to the one item of similar content; if not, service server 200 determines that the first content is not too similar to the one item of similar content. Note that if the similarity between the first content and the similar content is determined to be at least a predetermined value using the method described with reference to steps S122 and S123, the first content may be determined to be too similar to the one item of similar content.

If the first content is determined to be too similar to the one item of similar content (Yes in S104), service server 200 rejects the issuance of the NFT based on the NFT issuance request (S105). Accordingly, service server 200 does not send, to the blockchain system, transaction data including request information requesting the blockchain system to issue the NFT based on the NFT issuance request. As a result, no NFT is issued, which makes it possible to reduce the amount of processing performed by the processor to issue the NFT, and the amount of memory used to register the NFT on the blockchain.

Service server 200 then notifies terminal 100 that the issuance of an NFT based on the NFT issuance request will be rejected (S106).

If the first content is determined not to be too similar to the one item of similar content (No in S104), service server 200 sends, to terminal 100, the list of similar content generated in step S103, as well as information including a query for confirming whether the creator generated the first content with reference to the similar content included in the list (S107).

Upon receiving the information including the query, terminal 100 displays the query, and receives an answer to the query from the creator. Terminal 100 then sends the received answer to service server 200 (S108).

Based on the answer, service server 200 generates transaction data including request information requesting the blockchain system to issue an NFT corresponding to the first content (S109). For example, service server 200 generates transaction data including request information including a correspondence relationship associated with approved content which, among the one or more items of similar content identified through the search, has been approved by the answer from the creator. In other words, in the request information, correspondence relationships associated with content not approved by the answer from the creator are excluded.

Note that the request information includes information necessary for generating the NFT for the first content. The information necessary for generating the NFT is the information included in the NFT illustrated in FIG. 5. In other words, the request information includes a list of one or more correspondence relationships generated.

Service server 200 sends the generated transaction data to management server 300a and the like (S110).

Management server 300a and the like issue a new NFT by storing the transaction data in the blockchain, executing the smart contract code for issuing an NFT, and generating a new NFT ID (S111). Management server 300a and the like may register the NFT in the blockchain by storing the issued NFT ID in the distributed ledger.

Management server 300a and the like send the issued NFT ID to service server 200 (S112).

Upon obtaining the NFT ID, service server 200 may store the obtained NFT ID in association with first content (S113).

Note that upon obtaining the NFT ID, service server 200 may notify terminal 100 of the obtained NFT ID.

Although the first example described automatically identifying content similar to the first content by calculating features of the first content and comparing those features with the features of existing second content, the configuration is not limited thereto. For example, the creator may notify service server 200 of the second content referenced when generating the first content, and service server 200 may identify the similar content based on the notification from the creator, as in a second example.

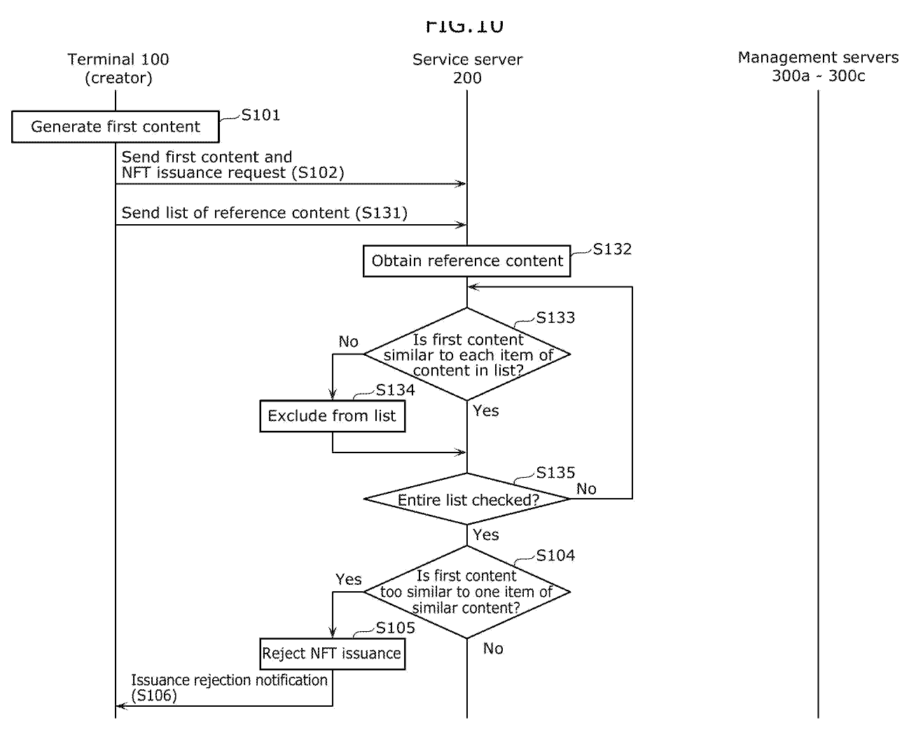

FIG. 10 is a sequence chart illustrating a second example of operations performed by the system according to the embodiment.

In the second example, steps S131 to S135 are executed instead of step S103 in the first example. Accordingly, steps S131 to S135 will be described here.

The creator operates terminal 100 and generates a list of the second content referenced in order to generate the first content (reference content). Accordingly, terminal 100 generates a list of the reference content, and sends the generated list to service server 200 (S131). As a result, service server 200 obtains the list of reference content. The list of reference content also includes a reference range, and is therefore also a list of correspondence relationships for which notifications have been made by the creator.

Upon obtaining the list of reference content, service server 200 obtains one or more items of reference content included in the list from the content DB (S132).

Based on a comparison between one of the one or more items of reference content (content to be processed) and the first content, service server 200 determines whether the content to be processed is similar to the first content (S133). The processing performed in steps S121 and S122 may also be used in this determination.

If the content to be processed is determined not to be similar to the first content (No in S133), service server 200 excludes the content to be processed from the list of reference content (S134).

However, if the content to be processed is determined to be similar to the first content (Yes in S133), service server 200 leaves the content to be processed in the list of reference content.

Service server 200 determines whether the processing of step S133 has been executed and the content qualifies as similar content for all of the one or more items of reference content in the list (S135). If all the reference content is determined to have been inspected (Yes in S135), service server 200 executes the following step S104, whereas if all the reference content is determined not to have been inspected (No in S135), service server 200 executes step S133 for the reference content not inspected.

In this manner, based on a comparison between each of the one or more items of reference content and the first content, service server 200 determines whether each of the one or more items of reference content is similar to the first content. Then, service server 200 identifies one or more items of content included in the list of reference content, after the inspection is complete for all the reference content, as one or more items of similar content similar to the first content. This list is also a list of correspondence relationships.

Effects, Etc.

Service server 200 according to the present embodiment performs the following control method. Service server 200 (a device) obtains an NFT issuance request for creating an NFT from first content (S102). Service server 200 sends, to a blockchain system, transaction data including request information for requesting the blockchain system to issue the NFT corresponding to the first content (S110). The NFT includes a correspondence relationship between first information and second information, the first information indicating a range of the first content where at least part of second content different from the first content is present, and the second information indicating a range of the second content where the at least part of the second content is present. The request information includes the correspondence relationship.

Through this, the first information indicating the range of the first content where at least a part of the second content is present, and the second information indicating the range of the second content where at least a part of the second content is present, are associated with each other by the correspondence relationship. Additionally, an NFT including the correspondence relationship can be stored in the blockchain. Accordingly, a correspondence relationship between parts that are common in the first content and the second content can easily be identified on the blockchain.

Through this, even if further additional content includes a part of the second content, recording a correspondence relationship between the additional content and the second content in the same manner as the correspondence relationship between the first content and the second content makes it possible to identify whether the part of the first content included in the second content is included in the additional content. In this manner, even if subsequent content is generated so as to share a part of the previous content, and the subsequent content is generated across a plurality of generations, the content whose part is included in the new content can be identified with ease.

In this manner, when an interest in new content arises, other content included in the new content can be identified, which makes it possible to easily distribute profit from the interest that has arisen to the creator or the owner of the other content included in the new content. In other words, all the people involved in the generation of the new content can be identified, which makes it possible to select candidates to which the profit produced by the new content is to be distributed from among those people. In this manner, candidates to which the profit produced by the new content is to be distributed can be selected from among all the people involved in the generation of the new content, and it is therefore possible that the profit will be distributed fairly.

In the control method according to the present embodiment, the second content is content referenced when a creator generates the first content.

Accordingly, a correspondence relationship between parts that are common between the first content and the second content referenced when generating the first content can easily be identified on the blockchain.

In the control method according to the present embodiment, the first information indicates a temporal range of the first content where the at least part of the second content is present. The second information indicates a temporal range of the second content where the at least part of the second content is present.

Accordingly, a correspondence relationship between temporal ranges, in which parts that are common between the first content and the second content referenced when generating the first content are present in each of the first content and the second content, can be identified with ease on the blockchain.

In the control method according to the present embodiment, the first information indicates a spatial range of the first content where the at least part of the second content is present. The second information indicates a spatial range of the second content where the at least part of the second content is present.

Accordingly, a correspondence relationship between spatial ranges, in which parts that are common between the first content and the second content referenced when generating the first content are present in each of the first content and the second content, can be identified with ease on the blockchain.

In the control method according to the present embodiment, the first content and the second content associated with each other by the correspondence relationship are of a same type.

In the control method according to the present embodiment, each of the first content and the second content includes a plurality of types of sub-content. The correspondence relationship includes a first correspondence relationship for a first type of the sub-content and a second correspondence relationship for a second type of the sub-content.

Accordingly, a correspondence relationship can be recorded on the blockchain for each type of sub-content included in each of the first content and the second content.

In the control method according to the present embodiment, the plurality of types of sub-content include image content and audio content. The first type of the sub-content is the image content. The second type of the sub-content is the audio content. The first correspondence relationship includes a correspondence relationship between temporal ranges where the at least part of the second content is present and a correspondence relationship between spatial ranges where the at least part of the second content is present. The second correspondence relationship includes a correspondence relationship between the temporal ranges where the at least part of the second content is present.

In the control method according to the present embodiment, service server 200 further searches a plurality of items of content stored in a storage device for one or more items of similar content similar to the first content. Service server 200 generates the correspondence relationship for each of one or more combinations of each of the one or more items of similar content and the first content. The request information is information requesting the blockchain system to issue an NFT including one or more correspondence relationships, each being the correspondence relationship generated.

Accordingly, a correspondence relationship between the first content and each of the one or more items of similar content among the plurality of items of content already stored in the storage device can be recorded on the blockchain.

In the control method according to the present embodiment, the searching by service server 200 includes extracting a feature of the first content based on the first content, and searching for the one or more items of similar content similar to the first content by comparing the feature with a feature of each of the plurality of items of content.

This makes it possible to appropriately search for the one or more items of similar content similar to the first content.

In the control method according to the present embodiment, when a first item of similar content, among the one or more items of similar content, includes all the first content, service server 200 skips the sending of the transaction data to the blockchain system.

Accordingly, the creation of an NFT for the same content as content for which an NFT has already been created can be rejected.

In the control method according to the present embodiment, the obtaining further includes service server 200 obtaining a list of one or more items of reference content referenced when a creator generates the first content. In the control method, service server 200 further obtains, based on the list, the one or more items of reference content from a storage device storing a plurality of items of content. Service server 200 identifies one or more items of similar content similar to the first content based on a comparison between each of the one or more items of reference content and the first content. Service server 200 generates the correspondence relationship for each of one or more combinations of each of the one or more items of similar content and the first content. The request information is information requesting the blockchain system to issue an NFT including one or more correspondence relationships, each being the correspondence relationship generated.

Accordingly, one or more items of similar content can be identified from one or more items of reference content included in the list.

### Supplemental Descriptions

Supplemental descriptions of the distributed ledger used in the foregoing embodiment or variations will be given next. Although a blockchain is described here as an example of a distributed ledger, the same applies to other distributed ledgers as well.

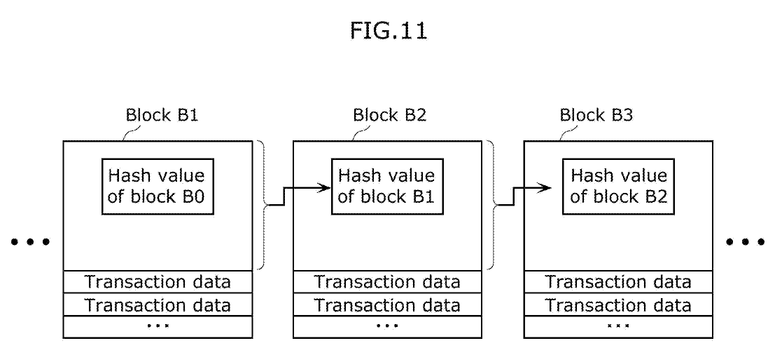

FIG. 11 is an explanatory diagram illustrating the data structure of a blockchain.

A “blockchain” is a connection of blocks, which serve as a unit of record, in the form of a chain. Each block includes a plurality of instances of transaction data and a hash value of the block immediately previous in the chain. Specifically, block B2 includes the hash value of block B1, which is immediately previous in the chain. A hash value computed from the plurality of instances of transaction data included in block B2 and the hash value of block B1 is then included in block B3 as the hash value of block B2. Connecting the blocks in a chain with each block including the details of the previous block as a hash value in this manner makes it possible to effectively prevent tampering with the recorded transaction data.

If, for example, a past instance of transaction data has been changed, the hash value of the block will have a value different from the pre-change value. This means that to make a block which has been tampered with appear normal, it is necessary to rebuild all the blocks previous thereto, which is a task that is extremely difficult in practice. This characteristic is used to ensure that it is difficult to tamper with the blockchain.

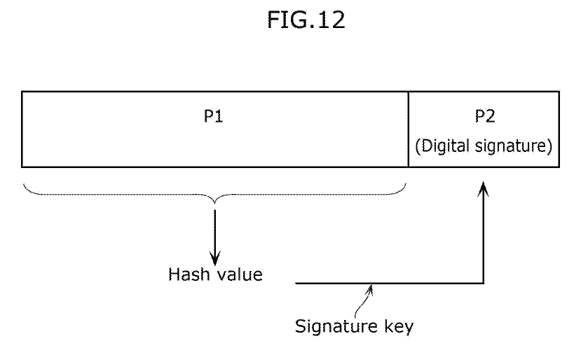

FIG. 12 is an explanatory diagram illustrating the data structure of transaction data.

The transaction data illustrated in FIG. 12 contains main transaction part P1 and digital signature P2. Main transaction part P1 is the main data of that transaction data. Digital signature P2 is a digital signature generated using a signature key of the creator of the transaction data on the hash value of main transaction part P1, and more specifically, is generated by encrypting the hash value using a private key of the creator of the transaction data. The digital signature method is, for example, the Elliptic Curve Digital Signature Algorithm (ECDSA), CRYSTALS-Dilithium, Falcon, SPHINCS+, or the like.

The transaction data has digital signature P2 and is therefore substantially impossible to be tampered with. This is because if the transaction data is tampered with, verification using digital signature P2 will fail, making it clear that the transaction data has been tampered with. This prevents main transaction part P1 itself from being tampered with.

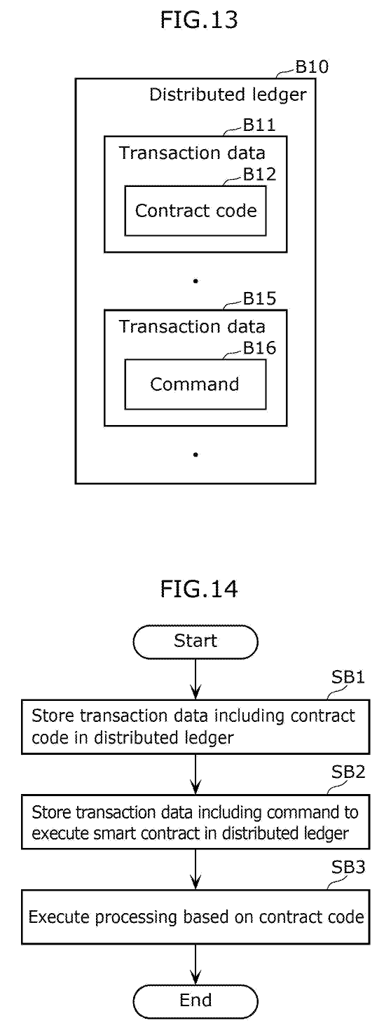

FIG. 13 is an explanatory diagram illustrating transaction data related to the execution of a smart contract. FIG. 14 is an explanatory diagram illustrating processing related to the execution of a smart contract.

A series of processing for executing a smart contract using a distributed ledger will be described with reference to FIGS. 13 and 14.

In step SB1, a node stores transaction data B11, including contract code B12 describing the processing of the smart contract, in distributed ledger B10. For example, the node obtains transaction data B11 by receiving transaction data B11 through communication from an information processing device, or by the node itself generating transaction data B11, and stores transaction data B11 obtained in distributed ledger B10. Step SB1 is performed before executing the smart contract.

In step SB2, the node stores transaction data B15, including command B16 to execute the smart contract, in distributed ledger B10. For example, the node receives transaction data B15 through communication from an information processing device, and stores transaction data B15 received in distributed ledger B10.

In step SB3, the node reads out contract code B12 from distributed ledger B10 in response to transaction data B15, including command B16, being stored in distributed ledger B10 in step SB2, and executes processing based on contract code B12. The result of the processing may be included in the transaction data and stored in distributed ledger B10.

Through the foregoing series of processing, when transaction data B15 including command B16 to execute the smart contract is received, the distributed ledger system automatically (i.e., without requiring work to be performed by a person) executes processing in accordance with command B16, and thus the processing can be executed with a high level of efficiency (i.e., quickly, or in a short period of time). Implementing highly-efficient processing has the effect of reducing power consumption. In addition, because work by a person is not required, situations where a person tampers with the information, acts improperly, or makes a human error can be avoided. Furthermore, the result of the processing executed in this manner is stored in the blockchain, which can make it substantially impossible for the result of the processing to be tampered with.

In the foregoing embodiment and variations, the constituent elements are constituted by dedicated hardware. However, the constituent elements may be realized by executing software programs corresponding to those constituent elements. Each constituent element may be realized by a program executing unit such as a CPU or a processor reading out and executing a software program recorded into a recording medium such as a hard disk or semiconductor memory. Here, the software that realizes the information processing device (i.e., a virtual space management server) and the like according to the foregoing embodiment and variations is a program such as that described below.

In other words, the program is a program for causing a computer to execute a control method performed by a device. The control method includes obtaining a non-fungible token (NFT) issuance request for creating an NFT from first content, and sending, to a blockchain system, transaction data including request information for requesting the blockchain system to issue the NFT corresponding to the first content. The NFT includes a correspondence relationship between first information and second information, the first information indicating a range of the first content where at least part of second content different from the first content is present, and the second information indicating a range of the second content where the at least part of the second content is present. The request information includes the correspondence relationship.

A device (service server 200) and the like according to one or more aspects have been described based on embodiments, but the present disclosure is not limited to these embodiments. Variations on the embodiment conceived by one skilled in the art, embodiments implemented by combining constituent elements from different other embodiments, and the like may be included in the scope of one or more aspects as well, as long as they do not depart from the essential spirit of the present disclosure.

### INDUSTRIAL APPLICABILITY

The present disclosure can be used as a control method and the like enabling the recording of a correspondence relationship between first content and second content sharing at least a part of the first content.

1. A control method performed by a device, the control method comprising: obtaining a non-fungible token (NFT) issuance request for generating an NFT from first content; and sending, to a blockchain system, transaction data including request information for requesting the blockchain system to issue the NFT corresponding to the first content, wherein the NFT includes a correspondence relationship between first information and second information, the first information indicating a range of the first content where at least part of second content different from the first content is present, and the second information indicating a range of the second content where the at least part of the second content is present, and the request information includes the correspondence relationship.

2. The control method according to claim 1, wherein the second content is content referenced when a creator generates the first content.

3. The control method according to claim 1, wherein the first information indicates a temporal range of the first content where the at least part of the second content is present, and the second information indicates a temporal range of the second content where the at least part of the second content is present.

4. The control method according to claim 1, wherein the first information indicates a spatial range of the first content where the at least part of the second content is present, and the second information indicates a spatial range of the second content where the at least part of the second content is present.

5. The control method according to claim 1, wherein the first content and the second content associated with each other by the correspondence relationship are of a same type.

6. The control method according to claim 5, wherein each of the first content and the second content includes a plurality of types of sub-content, and the correspondence relationship includes a first correspondence relationship for a first type of the sub-content and a second correspondence relationship for a second type of the sub-content.

7. The control method according to claim 6, wherein the plurality of types of sub-content include image content and audio content, the first type of the sub-content is the image content, the second type of the sub-content is the audio content, the first correspondence relationship includes a correspondence relationship between temporal ranges where the at least part of the second content is present and a correspondence relationship between spatial ranges where the at least part of the second content is present, and the second correspondence relationship includes a correspondence relationship between the temporal ranges where the at least part of the second content is present.

8. The control method according to claim 1, further comprising: searching a plurality of items of content stored in a storage device for one or more items of similar content similar to the first content; and generating the correspondence relationship for each of one or more combinations of each of the one or more items of similar content and the first content, wherein the request information is information requesting the blockchain system to issue an NFT including one or more correspondence relationships, each being the correspondence relationship generated.

9. The control method according to claim 8, wherein the searching includes: extracting a feature of the first content based on the first content; and searching for the one or more items of similar content similar to the first content by comparing the feature with a feature of each of the plurality of items of content.

10. The control method according to claim 9, wherein when a first item of similar content, among the one or more items of similar content, includes all the first content, the sending of the transaction data to the blockchain system is skipped.

11. The control method according to claim 1, wherein the obtaining further includes obtaining a list of one or more items of reference content referenced when a creator generates the first content, the control method further comprising: obtaining, based on the list, the one or more items of reference content from a storage device storing a plurality of items of content; identifying one or more items of similar content similar to the first content based on a comparison between each of the one or more items of reference content and the first content; and generating the correspondence relationship for each of one or more combinations of each of the one or more items of similar content and the first content, and wherein the request information is information requesting the blockchain system to issue an NFT including one or more correspondence relationships, each being the correspondence relationship generated.

12. A device comprising: a processor; and memory, wherein using the memory, the processor: obtains a non-fungible token (NFT) issuance request for generating an NFT from first content; and sends, to a blockchain system, transaction data including request information for requesting the blockchain system to issue the NFT corresponding to the first content, the NFT includes a correspondence relationship between first information and second information, the first information indicating a range of the first content where at least part of second content different from the first content is present, and the second information indicating a range of the second content where the at least part of the second content is present, and the request information includes the correspondence relationship.

13. A non-transitory computer-readable recording medium having recorded thereon a program for causing a computer to execute a control method performed by a device, the control method comprising: obtaining a non-fungible token (NFT) issuance request for generating an NFT from first content; and sending, to a blockchain system, transaction data including request information for requesting the blockchain system to issue the NFT corresponding to the first content, wherein the NFT includes a correspondence relationship between first information and second information, the first information indicating a range of the first content where at least part of second content different from the first content is present, and the second information indicating a range of the second content where the at least part of the second content is present, and the request information includes the correspondence relationship.
